(19) United States
(12) Patent Application Publication
(10) Pub. No.: US 2017/0159920 A1
(43) Pub. Date: Jun. 8, 2017

(54) HYBRID SOLAR/CONVENTIONAL BARRICADE LIGHT

(71) Applicant: Checkers Industrial Products, LLC, Broomfield, CO (US)

(72) Inventor: Scott Clifford, Mesa, AZ (US)

(73) Assignee: Checkers Industrial Products, LLC, Broomfield, CO (US)

(21) Appl. No.: 14/960,081

(22) Filed: Dec. 4, 2015

(51) Int. Cl. F21V 23/00; F21S 9/02; F21S 9/03; F21V 5/04; F21V 15/01; F21V 23/06

(52) U.S. Cl. CPC F21V 23/009; F21V 15/01; F21V 23/06; F21S 9/037; F21V 5/04; F21S 9/02; F21W 2111/02

(57) ABSTRACT

A hybrid signaling light apparatus includes a housing, a light source connected to the housing, a lens assembly positioned around the light source and connected to the housing, and a controller connected to the light source. Multiple energy source connections are within the housing and connected to the controller, and the controller provides power to the light source from at least one of the energy source connections. Other signaling light apparatuses include a double-walled housing having an inner housing and an outer housing external to the inner housing. Some apparatuses have rotatable light sources and lens assemblies that can be rotated relative to a housing.

### TECHNICAL FIELD

The present disclosure generally relates to signaling light apparatuses used to alert and direct traffic of pedestrians and vehicles. More specifically, the present disclosure relates to signaling light apparatuses with improved housings and power supplies.

### BACKGROUND

Signaling lights, such as “barricade lights,” are used to improve the visibility of traffic-directing posts, cones, barricades, and delineators in dark conditions. The signaling lights may provide a steady glow or can be configured to blink when they are turned on. Because they operate in extreme conditions for long periods of time, there are high standards for their construction, durability, and longevity. They must be reliable even when exposed to extreme temperatures, harsh weather conditions, and high impact forces (including, for example, vehicle impacts) while they are used on roadways and other outdoor locations. Simultaneously, they are preferably designed to be inexpensive and simple to mass-produce since construction companies, municipalities, and other users ordinarily must distribute large numbers of the signaling lights.

Considering the operational requirements of these signaling lights, their power is typically provided from one of two types of sources. The first common source is a non-rechargeable set of batteries stored in the housing. For example, the light may have about four D-cell alkaline batteries within the housing that provide energy for the light source. The batteries provide power for long periods of time (e.g., months) and are relatively inexpensive. When the batteries die, however, the entire barricade light must usually be replaced because the batteries are labor-intensive and therefore are cost-prohibitive to remove and replace. The power circuits of the signaling light may fail to function once the voltage provided by the batteries falls below a specified voltage, so large batteries need to be provided to extend the life of the light for a desirable duration of time.

Second, the light may be powered by a generator system that may include a solar or photovoltaic panel. Because they are solar powered, they can stay operational for an essentially unlimited length of time. Usually, a rechargeable battery is positioned in the housing that is charged when the solar cells are exposed to sunlight, such as a rechargeable 18650 LiFePO battery. However, if the battery is depleted (e.g., if the solar cells are kept in the dark for a long period of time and there is a drain on the battery), the barricade light may be unable to turn on again, even if the solar cell is exposed to sunlight, since their inner circuitry is designed to use a minimum voltage provided by the battery that is greater than the voltage generated by the solar cells alone.

Additionally, although some signaling lights have a light source that may be turned relative to their base housings, conventional lights are damaged when the light source is turned through too much angular displacement due to connections being damaged between the light source and the electronics of the housing. For example, the rotation of the light source may pull on or otherwise damage wires or other connective materials, leading to failure of the signaling light. Accordingly, there is a need for improvements to barricade lights and other signaling lights.

### SUMMARY

One aspect of the present disclosure relates to a hybrid signaling light apparatus which may include a housing, a light source connected to the housing, and a lens assembly positioned around the light source and connected to the housing. A controller may be connected to the light source, with a first energy source connection within the housing and connected to the controller and a second energy source connection within the housing and connected to the controller. The controller may be configured to provide power to the light source from at least one of the first and second energy source connections.

In the hybrid signaling light apparatus, the first and second energy source connections may each be configured to connect a different type of energy source to the controller. The first energy source connection may be connected to a generator, and the second energy source connection may be connected to an energy storage device. The generator comprise solar or photovoltaic panels. The apparatus may also further comprise a charging circuit having a battery, wherein the panels are configured to provide sufficient voltage to power the charging circuit independent of the battery or wherein the controller is configured to prevent over-charge of the battery via the charging circuit. In some embodiments, the panels may be selectively removable from and attachable to the housing.

The energy storage device may be selectively removable from and attachable to the housing by opening the housing. The first energy source connection may comprise a rechargeable energy source type and a non-rechargeable energy source type. The controller may be configured to provide power from only one of the first or second energy source connections at a time. The controller may comprise a buck-boost converter and a boost converter. The buck-boost converter may power the light source and the boost converter may power a processor.

Another aspect of the disclosure relates to a double-walled housing signaling light apparatus, which comprises an inner housing and an outer housing, with the outer housing being positioned external to the inner housing. A light source may be connected to the inner housing and a lens assembly may be positioned around the light source and connected to the outer housing. A controller may be connected to the light source, and an energy source connection may be positioned within the inner housing and connected to the controller.

In some arrangements, the outer housing may be removable from the inner housing. The light source may be rotatable relative to at least one of the inner or outer housings. The inner housing may comprise an energy storage device compartment, and the energy storage device compartment may be covered by a compartment door. The compartment door may be covered by the outer housing. The apparatus may also include a bolt and a nut plate, wherein the nut plate may have a threaded through-hole and a plurality of threaded locking members. The bolt may extend through the inner and outer housings and may be threadably engaged with the through-hole and the plurality of threaded locking members.

In another embodiment, a rotatable signaling light apparatus is provided. The apparatus may comprise a housing, a controller positioned in the housing, an energy source connection positioned in the housing and connected to the controller, a light source rotatably connected to the controller and rotatably connected to the housing, and a lens assembly positioned around the light source.

The light source may be infinitely rotatable relative to the controller. The apparatus may also comprise a light bracket connecting the light source to the housing, with the light bracket being removable from the housing. The light source may be removable from the light bracket. The light source may also be connected to the controller using a plug-and-socket electrical connector. The lens assembly may be rotatable relative to the housing, and rotation of the light source and the lens assembly may be synchronized.

The above summary of the present invention is not intended to describe each embodiment or every implementation of the present invention. The Figures and the detailed description that follow more particularly exemplify one or more preferred embodiments.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1A is a view of the exterior of a signaling light apparatus according to an embodiment of the present disclosure.

FIG. 1B is a another view of the apparatus of FIG. 1A.

FIG. 2A is an exploded view of the lens assembly and outer housing of the apparatus of FIG. 1A.

FIG. 2B is an exploded view of the apparatus of FIG. 1A.

FIG. 3A is a view of the apparatus of FIG. 1A with the lens assembly and outer housing removed.

FIG. 3B is a view of the apparatus of FIG. 3A with a door and battery removed.

FIG. 3C is a another view of the apparatus of FIG. 3A.

FIG. 3D is a section view of the top portion of the apparatus of FIG. 3A through a light source.

FIG. 4A shows electrical components of the apparatus of FIG. 3A.

FIG. 4B shows another view of the electrical components of FIG. 4A and has the batteries removed.

FIG. 5 is a schematic circuit diagram of an LED driving circuit according to an embodiment of the present disclosure.

FIG. 6 is a schematic circuit diagram of a solar charging circuit according to an embodiment of the present disclosure.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The present disclosure generally relates to signaling light assemblies and related methods that are durable, reconfigurable, inexpensive to produce, and have improved power circuits, systems, and controllers. In one embodiment, a hybrid signaling light apparatus is provided that has two different energy source connections within a housing, and a controller in the housing is configurable to provide energy to a light source in the apparatus from at least one of the two different energy source connections. Thus, the hybrid signaling light may be configured to use one of multiple possible energy sources. One of the energy sources may be an energy storage device (e.g., a battery or fuel cell), and another energy source may be a generator (e.g., a solar or photovoltaic (PV) generator). The generator may also comprise an energy storage device such as a rechargeable battery that may be recharged using the generator. The energy storage device and/or generator may be removable from the housing of the apparatus as part of selecting an energy source connection to be used by the light source of the signaling light apparatus. Thus, the apparatus may provide a signaling light with versatility in its energy source.

Another aspect of the disclosure relates to a signaling light apparatus that is double-walled. The housing may comprise multiple layers (e.g., an inner housing and an outer housing) that are structurally configured to reinforce each other and make the apparatus impact- and crush-resistant. The inner and outer housings may be separable from each other for maintenance of the apparatus. For example, removing the outer housing may expose a battery compartment for convenient replacement of batteries in the housing. A light source may be accessible in the apparatus by removal of the outer housing and/or a lens assembly positioned around it.

Yet another aspect of the disclosure relates to a rotatable signaling light apparatus that has a light source rotatably connected to a controller and rotatably connected to a housing. A lens assembly around the light may also be rotatable with the light source. The light source may be infinitely rotatable relative to the housing without damaging the power connection to the light source due to a specialized rotatable connection between the controller and the light source. In this case, “infinitely rotatable” may be defined as rotatable through thousands of degrees of rotation in one direction (e.g., clockwise or counter-clockwise) without any significant drawbacks (e.g., wire tangling, stretching, etc.) or significant wear or damage to the electrical connection between the light source and the controller. The light source may therefore be safely rotated while staying in electrical connection to the controller without damaging the controller or the connection therebetween. The lens assembly may also remain in its proper positioning relative to the light source as the light source turns.

The present description provides examples and is not limiting of the scope, applicability, or configuration set forth in the claims. Thus, it will be understood that changes may be made in the function and arrangement of elements discussed without departing from the spirit and scope of the disclosure, and various embodiments may omit, substitute, or add other procedures or components as appropriate. For instance, the methods described may be performed in an order different from that described, and various steps may be added, omitted, or combined. Also, features described with respect to certain embodiments may be combined in other embodiments.

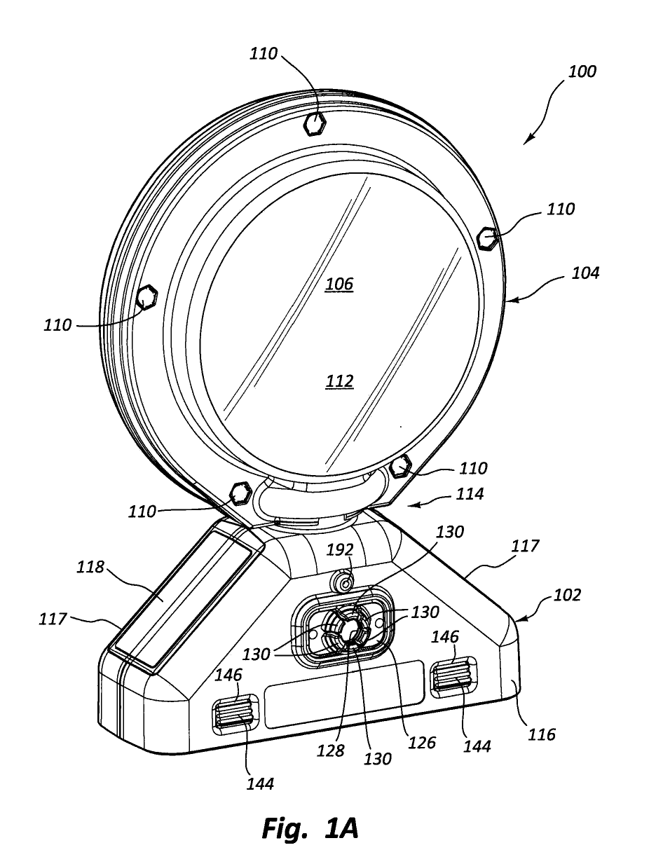

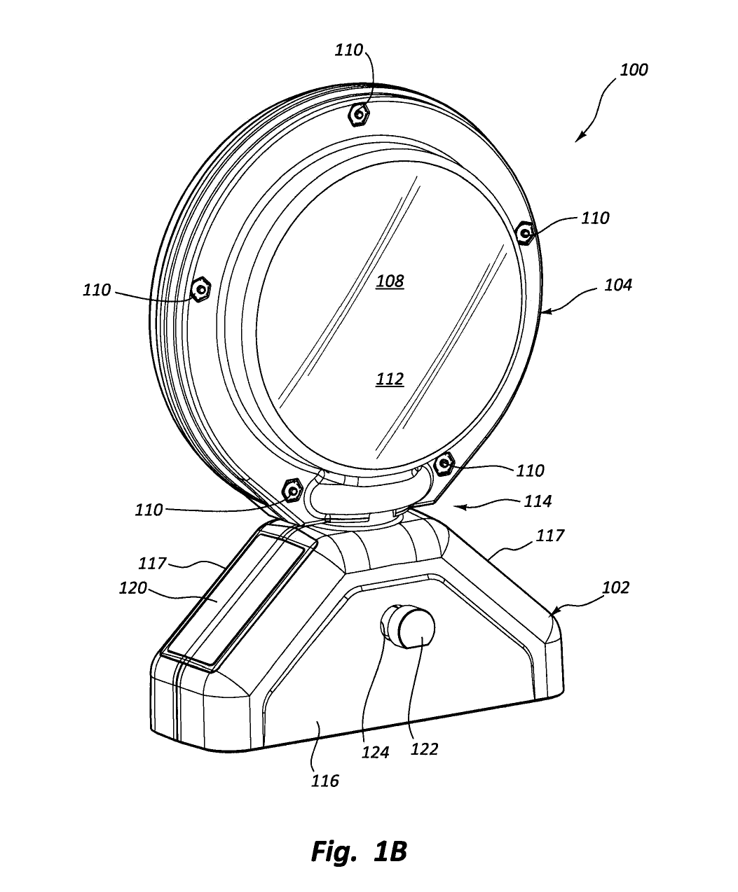

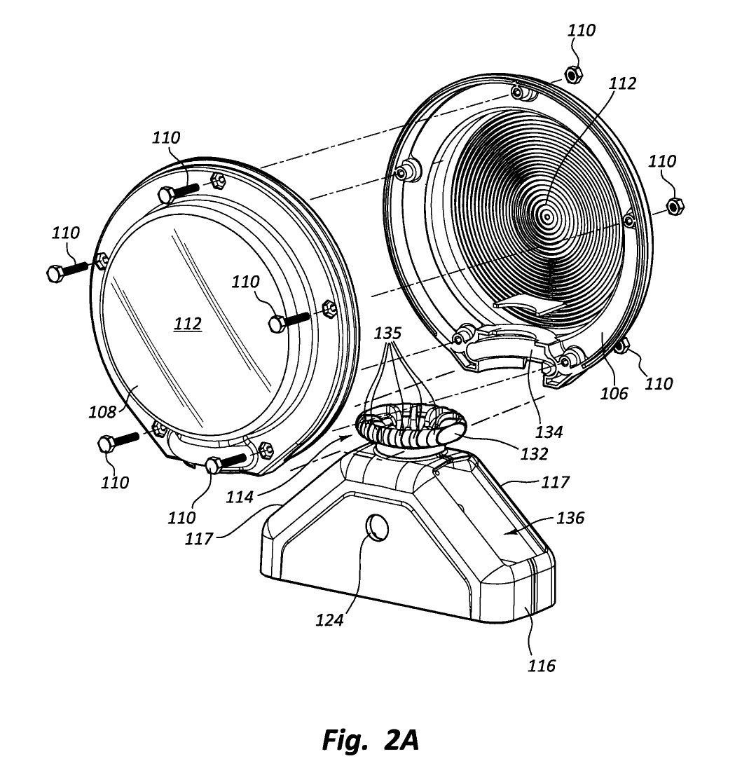

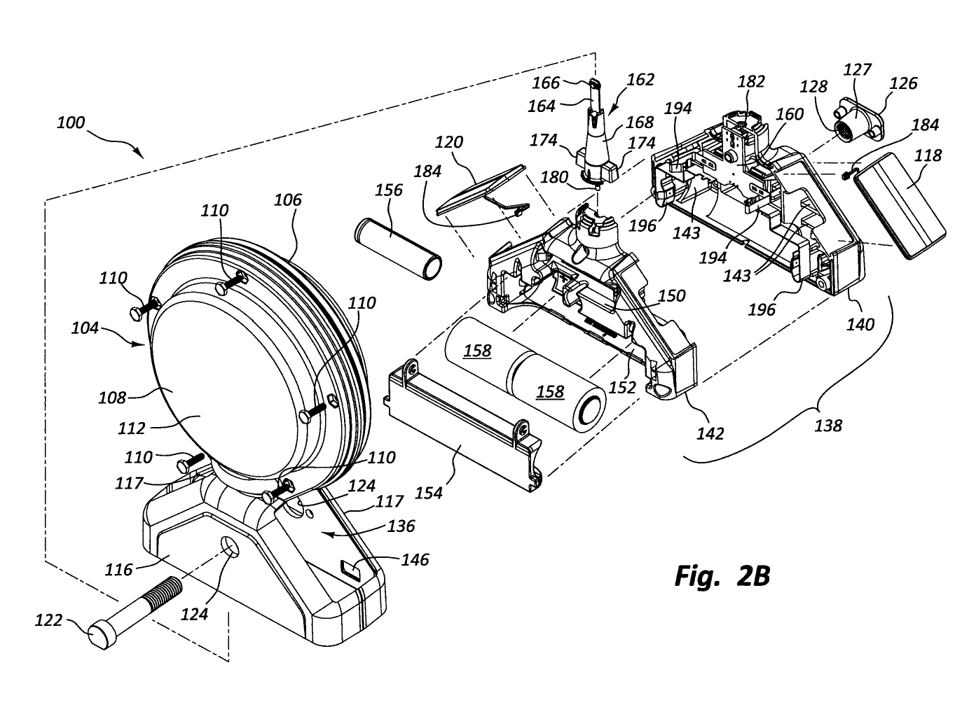

Turning now to the figures in detail, FIGS. 1A-1B show an external perspective view of a signaling light apparatus 100 according to the present disclosure. The signaling light apparatus 100 may comprise a base 102 and a lens assembly 104. The exterior of the lens assembly 104 may comprise a first side 106 and a second side 108 through which light is directed from an internal light source (see FIGS. 2-4B). The first and second sides 106, 108 may be attached to each other by fasteners 110 around their peripheries and may therefore be separable from each other by removal of the fasteners 110. The central portions 112 of the first and second sides 106, 108 may be configured to direct light predominantly horizontally and perpendicularly away from the lens assembly 104. For example, the central portions 112 may be configured as Fresnel lenses. See FIG. 2A. The entire lens assembly 104 may be rotatable relative to the base 102 (e.g., at neck 114) or may be held stationary relative to (i.e., affixed to) the base 102.

The base 102 may comprise an outer housing 116. The outer housing 116 may be partially inserted into or partially positioned within the lens assembly 104 at the neck 114. See FIG. 2A. The outer housing 116 may have angled side surfaces 117 that have solar panels 118, 120 connected therein. In embodiments where the solar panels 118, 120 are not used, the solar panels 118, 120 may be removed from the outer housing 116 and replaced with simple structural housing panels.

A bolt 122 may be positioned in a bolt aperture 124 that extends through the base 102. The threaded end of the bolt 122 that is inserted through the base 102 may engage a threaded portion 127 (see FIG. 2B) of a nut plate 126 positioned on the opposite side of the base 102. The threaded portion 127 of the nut plate 126 may comprise a threaded bolt aperture 128 through which the bolt 122 may extend. As the bolt 122 is threaded to the threaded portion 127, the threaded end of the bolt 122 may extend through the nut plate 126 and into contact with a plurality of locking members 130 on the nut plate 126. The plurality of locking members 130 may have internal surfaces with lock threads configured to lock the bolt 122 to the nut plate 126. Accordingly, the nut plate 126 may secure various lengths of bolts. Longer bolts may extend through the bolt aperture 128 and locking members 130, and shorter bolts may only engage to the threaded portion 127 or may engage the threaded portion 127 and the locking members 130 without extending as far through the bolt aperture 128 as a longer bolt. This feature may be advantageous since a user may not need to use a particular length of bolt 122 or a specific length of threaded portion on the bolt 122. Various lengths of bolts 122 may be used, so the signaling light apparatus 100 may be more convenient to the user since the use may use bolts 122 without concern over their length.

FIG. 2A shows an exploded view of the lens assembly 104 and outer housing 116 isolated from the rest of the signaling light apparatus 100. As shown in FIG. 2A, the outer housing 116 may comprise a radially-extending flange 132 at the neck 114 where the outer housing 116 interfaces with the lens assembly 104. The flange 132 may have a generally circular cross-section. The first and second sides 106, 108 of the lens assembly 104 may each comprise a housing groove 134 configured to receive the flange 132 on each side of the outer housing 116. Only the housing groove 134 of the first side 106 is shown in FIG. 2A, but a corresponding groove 134 may be positioned on the second side 108.

In some embodiments, the circular shapes of the flange 132 and housing grooves 134 allow the lens assembly 104 to rotate relative to the outer housing 116 while a mechanical interference between the flange 132 and grooves 134 prevents the lens assembly 104 from being pulled vertically off of the outer housing 116 without the first and second sides 106, 108 first being separated from each other. Accordingly, the lens assembly 104 may remain retained to the outer housing 116 while being pivotable or rotatable relative to the outer housing 116. In some arrangements, the flange 132 may comprise interlocking teeth 135 configured to engage meshing teeth (not shown) positioned within the housing grooves 134 of the lens assembly 104. With this configuration, the lens assembly 104 may be prevented from rotating and pivoting relative to the outer housing 116 due to the meshing of the teeth. In FIG. 2A, example teeth 135 are positioned on the flange 132 but not in the groove 134, so the lens assembly 104 is rotatable relative to the outer housing 116.

FIG. 2A also shows an example of the interior of the lens assembly 104. The first side 106 is shown having a central portion 112 having a Fresnel lens configuration to direct light from an internal light source in a primarily horizontal direction away from the central portion 112. The angled side surfaces 117 of the outer housing 116 are also shown in FIG. 2A, with an aperture 136 for the solar panels 118, 120 or other side panel inserts.

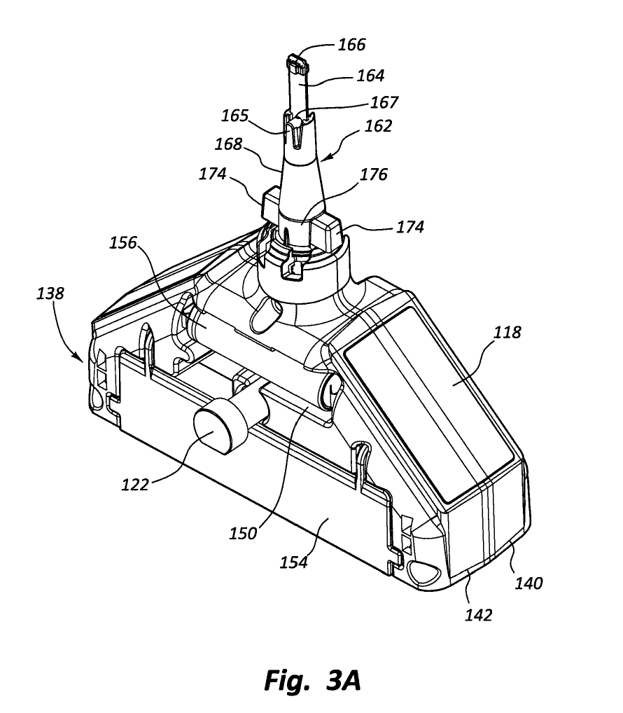

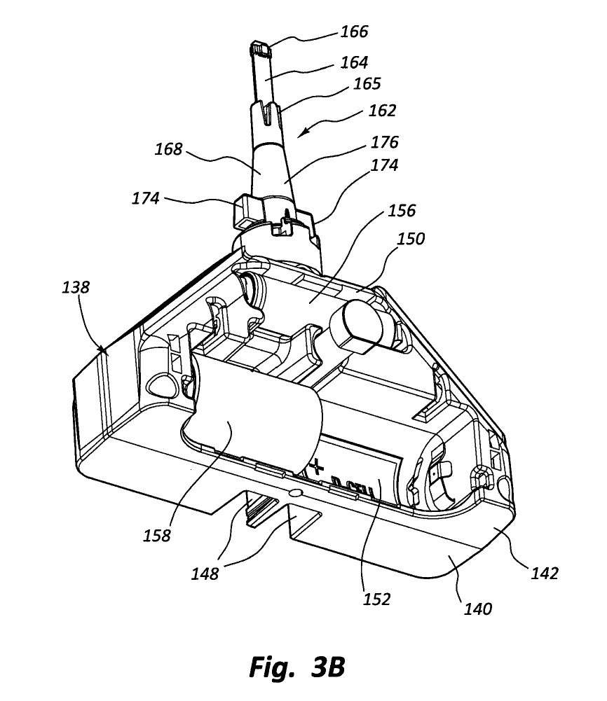

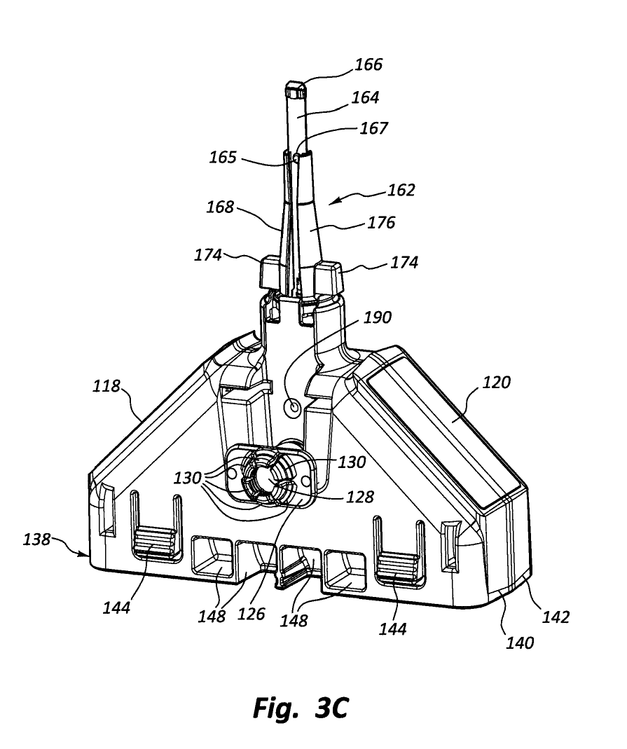

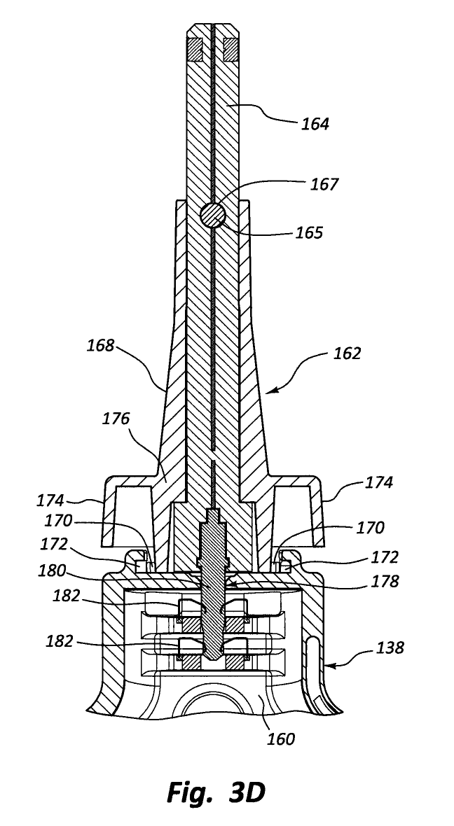

The base 102 may also comprise an inner housing 138. See FIGS. 2B-3C. The outer housing 116 and lens assembly 104 may be separable from the inner housing 138, as shown in FIG. 2B, leaving behind the inner housing 138 and components connected thereto, as shown in FIGS. 3A-3D. FIG. 2B shows an exploded view of the entire signaling light apparatus 100. The inner housing 138 may comprise a first side 140 and a second side 142 that are connectable to each other. The first and second sides 140, 142 may be snapped together or connected to each other by fasteners.

FIG. 3A shows a view of the exterior of the second side 142, FIG. 3B shows an alternate view of the second side 142, and FIG. 3C shows a view of the first side 140 of the inner housing 138. The first side 140 of the inner housing 138 comprises a plurality of push-tabs 144 that are configured to extend through tab apertures 146 in the outer housing 116. See FIGS. 1A and 3C. When the push-tabs 144 are pressed inward relative to the outer housing 116, they may recede through the tab apertures 146 to allow the outer housing 116 to move upward and separate from the inner housing 138. There may be a tight fit between the outer housing 116 and inner housing 138. Accordingly, the lower portion of the inner housing 138 may also comprise grasping recesses 148 to assist the user in separating the upper and lower housings 116, 138 after the push-tabs 144 are pressed internal to the outer housing 116.

To assemble the housings 116, 138, the outer housing 116 may slide over the top of the inner housing 138 until the push-tabs 144 are resiliently pressed inward by the bottom of the outer housing 116 (or are pressed inward by the user), and then the push-tabs 144 resiliently move back outward into the tab apertures 146 upon the outer housing 116 reaching its final attached position (i.e., the position of FIG. 1A). Thus, the signaling light apparatus 100 may be easily and quickly disassembled for maintenance or repairs. Aside from the optional bolt 122, the housings 116, 138 may be connected to each other without fasteners, glues or other adhesives, or other connecting devices that are time-consuming or potentially destructive to the apparatus 100 to remove. Accordingly, the housings 116, 138 may be described as being connected to each other by a non-destructive method and without fasteners.

The first and second sides 140, 142 of the inner housing 138 may be constructed with inwardly-extending reinforcing ribs. See, e.g., ribs 143 in FIG. 2B. The ribs 143 may further increase the stiffness of the inner housing 138 and make it resistant to bending, cracking, and/or caving inward. The ribs 143 may intersect and/or form a lattice of cross-shapes to reinforce each other.

The second side 142 of the inner housing 138 may comprise a first battery compartment 150 and a second battery compartment 152 (accessible through door 154; see FIGS. 3A-3B). A first energy storage device, such as first battery 156, may be positioned in the first battery compartment 150 and a second energy storage device, such as the set of second batteries 158, may be positioned in the second battery compartment 152. The door 154 may protect the set of second batteries 158 from impacts and may stiffen the lower portion of the inner housing 138 to reinforce the inner housing 138. Thus, the door 154 may strengthen the inner housing 138 to better withstand impact forces that could damage the set of second batteries 158 or deform or crack the lower portion of the inner housing 138. The first battery compartment 150 may be closer to the neck 114 and angled side surfaces 117 of the apparatus 100 than the second battery compartment 152, so it may therefore be within a portion of the outer and inner housings 116, 138 that is structurally stiffer than the second battery compartment 152. Thus, the first battery compartment 150 may be configured without a door 154. The first battery compartment 150 may, however, still covered and protected by the outer housing 116 when the signaling light apparatus 100 is assembled. Also, the first battery compartment 150 may be described as being in a structurally stiffer portion of the apparatus 100 or the in a portion of the apparatus 100 that has structural surfaces (e.g., 117) that are closer to each other than at the second battery compartment 152. Similarly, the second battery compartment 152 may be described as being in a portion of the apparatus 100 where the structural surfaces are farther apart in a lateral direction or the housing is less rigid than the housing around the first battery compartment 150.

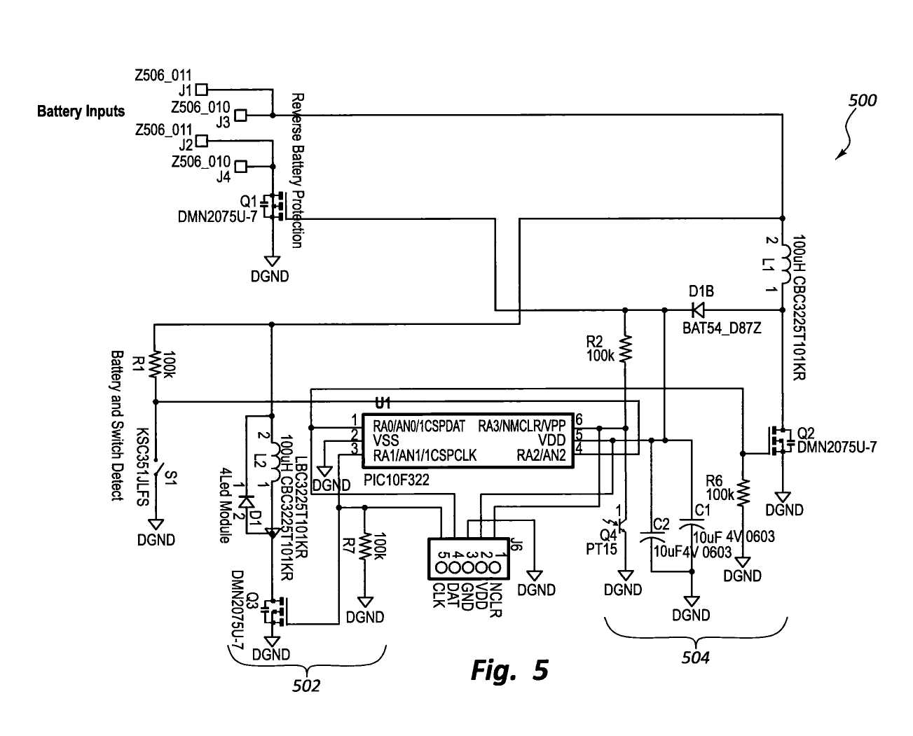

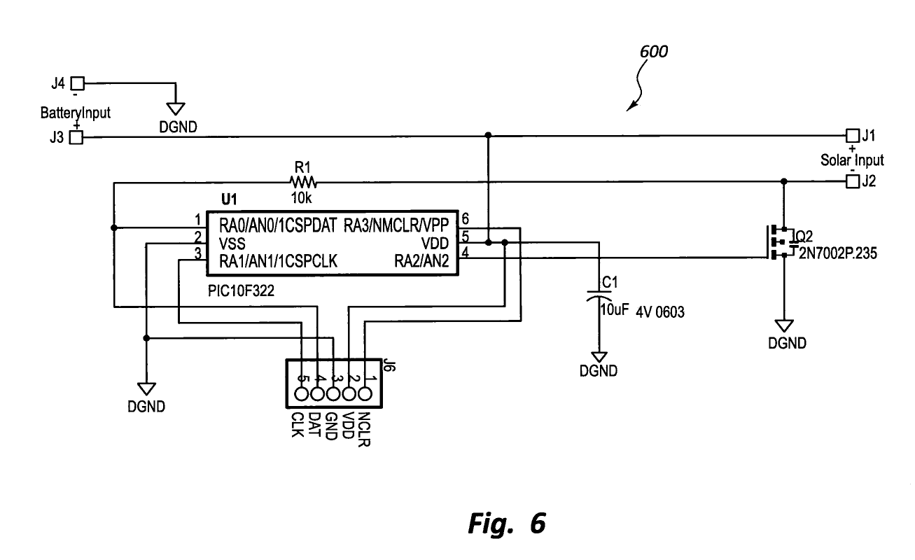

The first battery compartment 150 may contain a first battery 156. The first battery 156 may be a rechargeable battery that is connected to a controller 160 positioned in the inner housing 138. Rechargeable batteries may include secondary batteries such as, for example, lead acid, nickel-cadmium, nickel-metal-hydride, or lithium-ion batteries. The controller 160 may comprise a charging circuit 600 to recharge the first battery 156 using power generated by the solar panels 118, 120. See FIG. 6. The controller 160 may also comprise a power circuit (i.e., driving circuit 500) configured to provide energy to a light source 162 extending from the inner housing 138 and into the lens assembly 104. See FIG. 5. Thus, the controller 160 may comprise a processor or logic circuit that may be connected to a printed circuit board or another type of circuit. In some embodiments, the first battery 156 may be conventionally non-rechargeable, such as, for example, alkaline batteries.

The second battery compartment 152 may contain a set of second batteries 158. The set of second batteries 158 may be connected to the controller 160 in the inner housing 138. The set of second batteries 158 may be non-rechargeable as well. The power circuit of the controller 160 may be configured to provide energy to the light source 162 from the set of second batteries 158.

The controller 160 may be configured to provide power to the light source 162 from at least one of the first battery 156 and the set of second batteries 158. For example, the controller 160 may be configured to provide energy to the light source 162 from whichever of the two battery compartments 150, 152 have batteries installed. Thus, by not installing a battery in one of the two battery compartments 150, 152, the controller 160 may be automatically configured to draw energy from the compartment that has one or more batteries installed. In this way, the user may easily configure the type of energy source that the apparatus 100 will use by only installing a battery for the type of energy source that he or she wishes the apparatus 100 to use. The apparatus 100 may use a rechargeable energy source by using solar panels 118, 120 and first battery 156 or the apparatus may use a non-rechargeable energy source by using the set of second batteries 158. The second battery compartment 152 may be larger to accommodate more or larger batteries than the first battery compartment 150, especially in cases where the first battery compartment 150 is used with a rechargeable battery and the second battery compartment 152 is not.

In some arrangements, the controller 160 may draw power directly from the solar panels 118, 120 to power the light source 162. Thus, the user may configure the apparatus 100 to use solar panels by connecting solar panels 118, 120 to the housings 116, 138 or may configure the apparatus 100 to not use solar panels by removing the panels 118, 120 from the apparatus 100 or otherwise disabling the panels 118, 120.

The light source 162 is positioned at the top end of the inner housing 138. The light source 162 may comprise a printed circuit board (PCB) 164 having light-emitting diodes (LEDs) 166 positioned at a distal end. At least one LED may be positioned on each side of the PCB 164, as shown in FIGS. 3A and 3B. A light housing 168 may be connected to the PCB 164. The light housing 168 may be secured to the inner housing 138 by a mechanical interface, such as, for example, mechanical interference between a flange and a ridge, interlocking parts, a releasable snap-fit connection, or similar interface. As shown in FIG. 3D, the light housing 168 is held to the inner housing 138 by a snap-fit connection wherein the light housing 168 has an at least partially circumferential ridge 170 that is secured to the inner housing 138 in an at least partially circumferential groove 172 in the top of the inner housing 138.

While secured in the inner housing 138, the light housing 168 may be pivotable relative to the top of the inner housing 138 about a vertical/longitudinal axis extending through the PCB 164. Simultaneously, the connection between the inner housing 138 and the light housing 168 may prevent or inhibit removal of the light source 162 from the inner housing 138 in a vertical direction. When the signaling light apparatus 100 is assembled, the light source 162 is within the lens assembly 104 between the first and second sides 106, 108. The LEDs 166 may be configured to face outward through the central portions 112 of the first and second sides 106, 108 and may preferably primarily direct light perpendicular to the central portions 112 and the PCB 164.

If the lens assembly 104 is rotated, the LEDs 166 may be misaligned relative to the lens assembly 104 if they do not rotate with the first and second sides 106, 108. Therefore, in some arrangements, the light source 162 may rotate with the lens assembly 104 and they both may have synchronized rotation relative to the inner housing 138. To achieve synchronized rotation, the light source 162 and lens assembly 104 may be linked by protrusions 174 on the light housing 168 that extend radially outward from a central portion 176 of the light housing 168. The protrusions 174 may contact surfaces within the lens assembly 104 so that rotation of the lens assembly 104 applies a rotational force to the protrusions 174. Accordingly, the protrusions 174 may contact the lens assembly 104 as the lens assembly 104 rotates and thereby causes rotation of the protrusions 174.

The PCB 164 of the light source 162 may be separable from the light housing 168. In some cases, the PCB 164 may be removed by bending a retaining member 165 until it clears an aperture 167 through the PCB 164, at which point the PCB 164 may be drawn upward and out of the light housing 168. The PCB 164 may be reinstalled by moving it downward through the top of the light housing 168 (while bending the retaining member 165 away from the PCB 164) until the retaining member 165 can move back into the aperture 167. Thus, repair or replacement of the PCB 164 and LEDs 166 may require only partial disassembly of the light source 162 since the light housing 168 may remain connected to the inner housing 138 while the PCB 164 is serviced.

As the PCB 164 of the light source 162 rotates, the LEDs 166 remain in electrical communication with the controller 160 in order to stay lighted. While conventional barricade lights may have wiring between a light source and a controller, the wiring may be unreliable due to damage that can be caused by the relative rotation of the light source and controller pulling on or pinching the wires. However, embodiments of the present disclosure may comprise a rotatable connector 178 connecting the light source 162 to the controller 160. The rotatable connector 178 may comprise a stem 180 and socket connectors 182. The stem 180 may be on the light source 162 and the socket connectors 182 may be on the controller 160 (or vice versa). The stem 180 may be inserted into the socket connectors 182 and may be rotatable within the socket connectors 182 while maintaining electrical contact with the socket connectors 182. For example, the stem 180 may be configured as an audio jack or phone connector (e.g., tip-sleeve (TS) connector or tip-ring-sleeve (TRS) plug-and-socket connector). Thus, the rotatable connector 178 may maintain connection between the controller 160 and the light source 162 as they rotate relative to each other.

The rotatable connector 178 may also resist withdrawal of the stem 180 from the socket connectors 182 in a manner that may help keep the light source 162 from translating away from to the controller 160. For example, the socket connectors 182 may be spring-loaded or otherwise biased to clasp the stem 180 when the stem 180 is inserted therein, and a biasing force against the stem 180 may need to be overcome to withdraw the stem 180 from the socket connectors 182. When the PCB 164 is removed from the light housing 168, the stem 180 may simultaneously be removed from the socket connectors 182, and the light housing 162 may remain pivotably connected to the inner housing 138 by the circumferential ridge 170 and groove 172 interface.

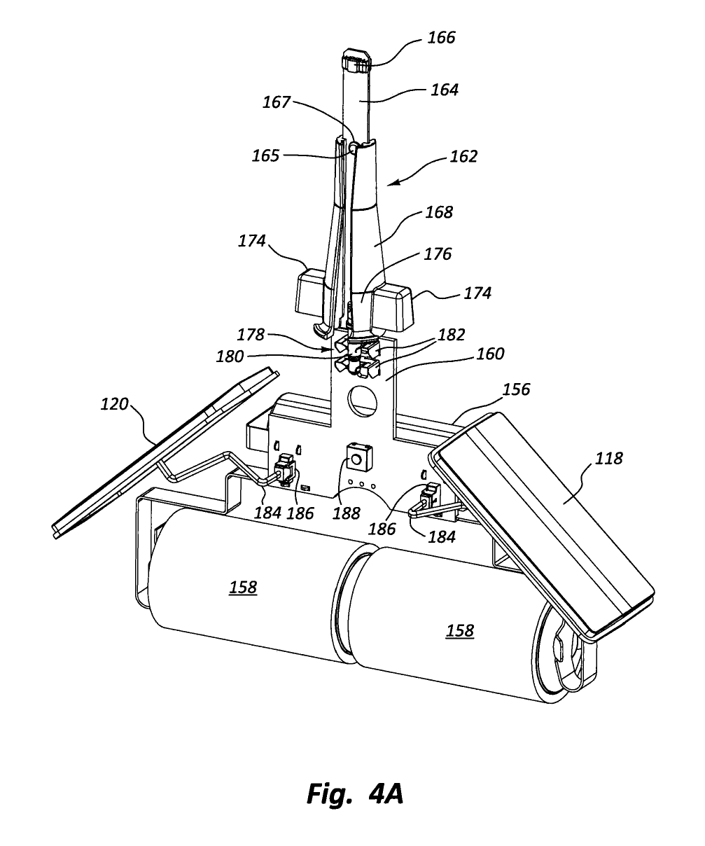

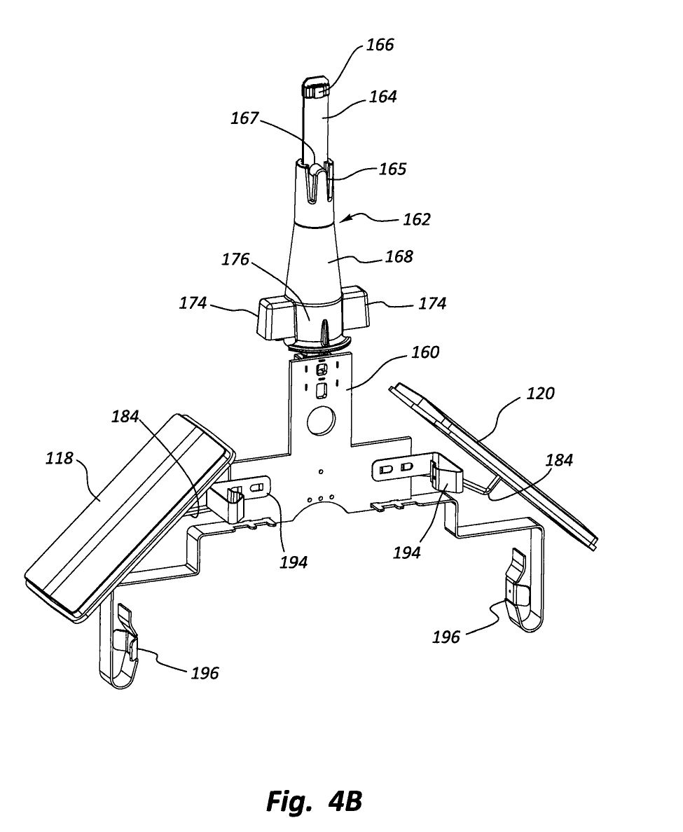

The solar panels 118, 120 may also comprise connectors 184 configured to link the solar panels 118, 120 to sockets 186 on the controller 160. See FIG. 4A. The sockets 186 and connectors 184 may be selectively removable from each other so that the solar panels 118, 120 may be non-destructively removed from the controller 160 (and the signaling light apparatus 100 in general) by simply pulling the connector 184 out of the socket 186. The sockets 186 may be accessed for service by separating the first and second sides 140, 142 of the inner housing 138.

The controller 160 may also comprise a control button 188. See FIG. 4A. The control button 188 may turn the light source 162 on and off or may set the light source 162 to blink in a pattern. The control button 188 may be accessed through the inner and outer housings 138, 116 through an inner button aperture 190 and an outer button aperture 192. See FIGS. 1A and 3C.

The first battery compartment 150 may be part of a first energy source connection and the second battery compartment 152 may be part of a second energy source connection. The first energy source connection may be collectively referred to as the connection (including, for example, the wiring, battery contactors, and circuitry) between the controller 160 and the first battery 156 and/or solar panels 118, 120. The second energy source connection may be collectively referred to as the connection between the controller 160 and the set of second batteries 158. FIG. 4B shows the controller 160 with the inner housing 138 and batteries 156, 158 hidden. This view illustrates how the controller 160 may be connected to the batteries 156, 158 using a first set of battery connectors 194 and a second set of battery connectors 196. The first set of battery connectors 194 may be part of the first energy source connection to the controller 160, and the second set of battery connectors 196 may be part of the second energy source connection to the controller 160.

FIG. 5 is a circuit diagram illustrating an embodiment of an LED driving circuit 500 that may be part of the controller 160. The LED driving circuit 500 may comprise a buck-boost converter 502 and a boost converter 504. The buck-boost converter 502 permits the driving circuit 500 to drive the LEDs 166 whether a high voltage or low voltage is provided by the first and/or second energy source connections. Accordingly, different voltages may be provided by each of the first and second energy source connections, yet the LED driving circuit 500 may still be able to provide proper voltage to the LEDs 166. If, for example, the first battery 156 provides a lower voltage than the set of second batteries 158, the LED driving circuit 500 may be able to adapt either voltage to drive at least one of a processor of the controller 160 and the light source 162. In an example embodiment, the LEDs 166 may be powered whether about 3.6 volts are provided to the LED driving circuit 500 or less than about 300 millivolts are provided thereto.

The boost converter 504 of the LED driving circuit 500 may allow a processor of the controller 160 to operate when an energy source connection to the controller 160 has a low charge or otherwise provides a low voltage. For example, when the set of second batteries 158 is used to power the controller 160, they may, over time, deplete their charge and provide a low voltage. Normally, the voltage would drop to a point where a conventional controller can no longer operate, but because of the boost converter 504, those low voltages may be increased to a functional value and keep the controller 160 operational for much longer than conventional signaling lights. For example, using two typical D-cell alkaline batteries as the set of second batteries 158, an additional four months of battery life may be achieved by using the boost converter 504 as compared to using four typical D-cell batteries in a conventional signaling light. Thus, the operational life of a signaling light apparatus 100 may be extended for long periods of time using the boost converter 504, even if the number of batteries or the overall energy capacity (e.g., as measured in watt-hours or amp-hours) of the energy source connection is less than conventional sources.

FIG. 6 shows a circuit diagram of a solar charging circuit 600 that may be part of a controller 160 used to implement embodiments of the present disclosure. The charging circuit 600 may be connected to solar panels 118, 120 on the signaling light apparatus 100. The charging circuit 600 may comprise a microprocessor unit that may be configured to operate when the signaling light apparatus 100 only receives power from the solar panels 118, 120, such as, for example, when the batteries (e.g., first battery 156) associated with the solar panels 118, 120 are depleted.

This configuration may be advantageous over conventional signaling light apparatuses. Conventional apparatuses may fail to operate if their battery voltage falls below a threshold value (e.g., 1.8 volts) because the solar panels only output a voltage that is less than that threshold value (e.g., 0.5 volts). Thus, if the battery is depleted, the charging circuit also fails since it does not have enough voltage to operate and recharge the depleted batteries. If the signaling light apparatuses are left in the dark too long, their batteries would deplete without a way to recharge via the solar panels. In contrast, embodiments having the solar charging circuit 600 of FIG. 6 can operate solely on the voltage provided by the solar panels 118, 120, so the first battery 156 may be charged when it is depleted and cannot power the microcontroller of the solar charging circuit 600 independently from the solar panels 118, 120.

The solar charging circuit 600 may also prevent overcharging of the battery by cut off charge to the battery when the battery voltage reaches a value near the voltage output by the solar panels 118, 120. For example, if the solar panels 118, 120 produce 3.6 volts, the solar charging circuit 600 may cut off charge to the battery when it reaches 3.4 volts. In this way, rechargeable batteries may remain at over 90 percent charge without overcharging.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.”

What is claimed is:

1. A hybrid signaling light apparatus, comprising:
a housing;
a light source connected to the housing;
a lens assembly positioned around the light source and connected to the housing;
a controller connected to the light source;
a first energy source connection within the housing and connected to the controller;
a second energy source connection within the housing and connected to the controller;
wherein the controller is configured to provide power to the light source from at least one of the first and second energy source connections.

2. The hybrid signaling light apparatus of claim 1, wherein the first and second energy source connections are each configured to connect a different type of energy source to the controller.

3. The hybrid signaling light apparatus of claim 1, wherein the first energy source connection is connected to a generator and the second energy source connection is connected to an energy storage device.

4. The hybrid signaling light apparatus of claim 3, wherein the generator comprises solar or photovoltaic panels.

5. The hybrid signaling light apparatus of claim 4, further comprising a charging circuit having a battery, wherein the panels are configured to provide sufficient voltage to power the charging circuit independent of the battery.

6. The hybrid signaling light apparatus of claim 4, further comprising a charging circuit having a battery, wherein the controller is configured to prevent over-charge of the battery via the charging circuit.

7. The hybrid signaling light apparatus of claim 4, wherein the panels are selectively removable from and attachable to the housing.

8. The hybrid signaling light apparatus of claim 3, wherein the energy storage device is selectively removable from and attachable to the housing by opening the housing.

9. The hybrid signaling light apparatus of claim 1, wherein the first energy source connection comprises a rechargeable energy source type and a non-rechargeable energy source type.

10. The hybrid signaling light apparatus of claim 1, wherein the controller only is configured to provide power from only one of the first or second energy source connections at a time.

11. The hybrid signaling light apparatus of claim 1, wherein the controller comprises a buck-boost converter and a boost converter.

12. The hybrid signaling light apparatus of claim 11, wherein the buck-boost converter powers the light source and the boost converter powers a processor.

13. A double-walled housing signaling light apparatus, comprising:
an inner housing;
an outer housing, the outer housing being positioned external to the inner housing;
a light source connected to the inner housing;
a lens assembly positioned around the light source and connected to the outer housing;
a controller connected to the light source;
an energy source connection positioned within the inner housing and connected to the controller.

14. The double-walled housing signaling light apparatus of claim 13, wherein the outer housing is removable from the inner housing.

15. The double-walled housing signaling light apparatus of claim 13, wherein the light source is rotatable relative to at least one of the inner or outer housings.

16. The double-walled housing signaling light apparatus of claim 13, wherein the inner housing comprises an energy storage device compartment, the energy storage device compartment being covered by a compartment door.

17. The double-walled housing signaling light apparatus of claim 16, wherein the compartment door is covered by the outer housing.

18. The double-walled housing signaling light apparatus of claim 13, further comprising a bolt and a nut plate, the nut plate having a threaded through-hole and a plurality of threaded locking members, wherein the bolt extends through the inner and outer housings and is threadably engaged with the through-hole and the plurality of threaded locking members.

19. A rotatable signaling light apparatus, comprising:
a housing;
a controller positioned in the housing;
an energy source connection positioned in the housing and connected to the controller;
a light source rotatably connected to the controller and rotatably connected to the housing;
a lens assembly positioned around the light source.

20. The rotatable signaling light apparatus of claim 19, wherein the light source is infinitely rotatable relative to the controller.

21. The rotatable signaling light apparatus of claim 19, further comprising a light bracket connecting the light source to the housing, the light bracket being removable from the housing.

22. The rotatable signaling light apparatus of claim 21, wherein the light source is removable from the light bracket.

23. The rotatable signaling light apparatus of claim 19, wherein the light source is connected to the controller using a plug-and-socket electrical connector.

24. The rotatable signaling light apparatus of claim 19, wherein the lens assembly is rotatable relative to the housing.

25. The rotatable signaling light apparatus of claim 24, wherein rotation of the light source and the lens assembly is synchronized.
